(19) United States
(12) Patent Application Publication
(10) Pub. No.: US 2014/0358596 A1
(43) Pub. Date: Dec. 4, 2014

(54) ENVIRONMENTALLY-FRIENDLY PARKING RESERVATION SYSTEM

(71) Applicant: International Business Machines Corporation, Armonk, NY (US)

(72) Inventors: Douglas Stuart Brown, Charlotte, NC (US); John Falk Kelley, Clarkesville, GA (US); Todd Seager, Orem, UT (US); Robert J. Torres, Cowlleyville, TX (US)

(21) Appl. No.: 13/906,554

(22) Filed: May 31, 2013

(51) Int. Cl. G06Q 50/30; G06Q 10/02

(52) U.S. Cl. CPC G06Q 50/30; G06Q 10/02
USPC 705/5

(57) ABSTRACT

A method, system, and computer program product for an environmentally-friendly parking reservation system are provided in the illustrative embodiments. A computer receives a request to make a reservation for parking a vehicle in a parking area. A parking location in the parking area is selected in an application, forming a selection. The computer modifies the selection based on a qualifier in the request, the qualifier indicating an environmentally-friendly aspect of the vehicle. The computer generates a response, the response identifying the parking location.

### TECHNICAL FIELD

The present invention relates generally to a method, system, and computer program product for reserving parking for automobiles. More particularly, the present invention relates to a method, system, and computer program product for an environmentally-friendly parking reservation system.

### BACKGROUND

A parking location is a designated place to park an automobile. A parking meter is one example of a parking location. A parking space equipped with a device to convey to users that the space is reserved or available for parking an automobile is another example of a parking location.

Finding a parking location under certain circumstances is not an easy task. Particularly, at crowded, built-up, or popular destinations, a user often has to drive around the parking area for a significant amount of time before finding a parking location.

The increase in the amount of space that can be allocated for parking automobiles has not kept up with the increasing number of automobiles on the streets. Finding a parking location at many destinations is going to become increasingly difficult as more people and more automobiles head to those destinations.

### SUMMARY

The illustrative embodiments provide a method, system, and computer program product for an environmentally-friendly parking reservation system. An embodiment receives a request to make a reservation for parking a vehicle in a parking area. The embodiment selects, in an application, a parking location in the parking area, forming a selection. The embodiment modifies the selection based on a qualifier in the request, the qualifier indicating an environmentally-friendly aspect of the vehicle. The embodiment generates a response, the response identifying the parking location.

Another embodiment includes one or more computer-readable tangible storage devices. The embodiment further includes program instructions, stored on at least one of the one or more storage devices, to receive a request to make a reservation for parking a vehicle in a parking area. The embodiment further includes program instructions, stored on at least one of the one or more storage devices, to select a parking location in the parking area, forming a selection. The embodiment further includes program instructions, stored on at least one of the one or more storage devices, to modify the selection based on a qualifier in the request, the qualifier indicating an environmentally-friendly aspect of the vehicle. The embodiment further includes program instructions, stored on at least one of the one or more storage devices, to generate a response, the response identifying the parking location.

Another embodiment includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to receive a request to make a reservation for parking a vehicle in a parking area. The embodiment further includes program instructions, stored on at least one of the one or more storage devices for execution by at least one of the one or more processors via at least one of the one or more memories, to select a parking location in the parking area, forming a selection. The embodiment further includes program instructions, stored on at least one of the one or more storage devices for execution by at least one of the one or more processors via at least one of the one or more memories, to modify the selection based on a qualifier in the request, the qualifier indicating an environmentally-friendly aspect of the vehicle. The embodiment further includes program instructions, stored on at least one of the one or more storage devices for execution by at least one of the one or more processors via at least one of the one or more memories, to generate a response, the response identifying the parking location.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an environmentally-friendly parking reservation system in accordance with an illustrative embodiment;

FIG. 4 depicts a block diagram of example features of supplementary services usable in accordance with an illustrative embodiment;

FIG. 5 depicts a flowchart of a process for an environmentally-friendly parking reservation system in accordance with an illustrative embodiment; and

FIG. 6 depicts an example process for modifying a selection of a parking location in accordance with an illustrative embodiment.

### DETAILED DESCRIPTION

The illustrative embodiments recognize that driving around a parking area to find an available parking location is a wasteful use of fuel. Such driving also pollutes the environment.

The illustrative embodiments further recognize that often many individuals start from a common location and reach a common destination, albeit in different vehicle. Such driving patterns exacerbate the fuel consumption and pollution problems.

The illustrative embodiments recognize that many parking areas are managed using some computerized parking management system, which can keep track of occupied and vacant parking locations over a given period. Some of these parking management systems are also capable of accepting reservations for parking an automobile in a parking area during a specified period.

The illustrative embodiments recognize that the presently available parking management systems are unable to assign a specific parking location to an automobile in response to a reservation request, such that the reservation is aware of, and promotes, environmentally friendly driving practices. The illustrative embodiments further recognize that presently available parking management systems are also unable to reserve a specific parking location by taking into account additional considerations such as additional revenue generating opportunities, user-preferences, users' patterns of parking usage, and other similar factors.

The illustrative embodiments used to describe the invention generally address and solve the above-described problems and other problems related to reserving parking locations. The illustrative embodiments provide a method, system, and computer program product for an environmentally-friendly parking reservation system.

The illustrative embodiments provide a system for reserving a parking location in advance to avoid the need to drive around to find a parking location. As an example, an embodiment incentivizes a user to travel with others in a common vehicle from one geographical area to another, to wit, car-pool (car-pooling), by modifying certain aspects of the reservation. For example, an embodiment modifies a reservation if the reservation request is for a vehicle that is being used for car-pooling. For example, if the parking locations are sorted in some order of desirability, the embodiment assigns a more desirable location to a car-pooling vehicle as compared to a location assigned to a vehicle that is not used for car-pooling.

As another example, an embodiment incentivizes a user to travel in a fuel-efficient vehicle, by modifying certain aspects of the reservation. For example, an embodiment modifies a reservation if the reservation request is for a vehicle that produces smaller than a threshold amount of greenhouse gases. For example, if the parking locations are sorted in some order of desirability, the embodiment assigns a more desirable location to a zero-emission vehicle as compared to a location assigned to a vehicle that is categorized as a low-emission vehicle. The embodiment assigns a more desirable location to a low-emission vehicle as compared to a location assigned to a vehicle that is not categorized as a zero-emission vehicle or a low-emission vehicle.

An embodiment can wirelessly receive reservation requests from a mobile data processing device—such as a smartphone or a mobile computing device available with a driver of a vehicle, or using a data processing system associated with an automobile—such as a navigation system, a communication system, a computer, or a combination thereof present in the vehicle.

The illustrative embodiments are described with respect to certain data processing systems, environment, distances, and measurements only as examples. Any specific manifestations of such artifacts are not intended to be limiting to the invention. Any suitable manifestation of data processing systems, environment, distances, and measurements can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

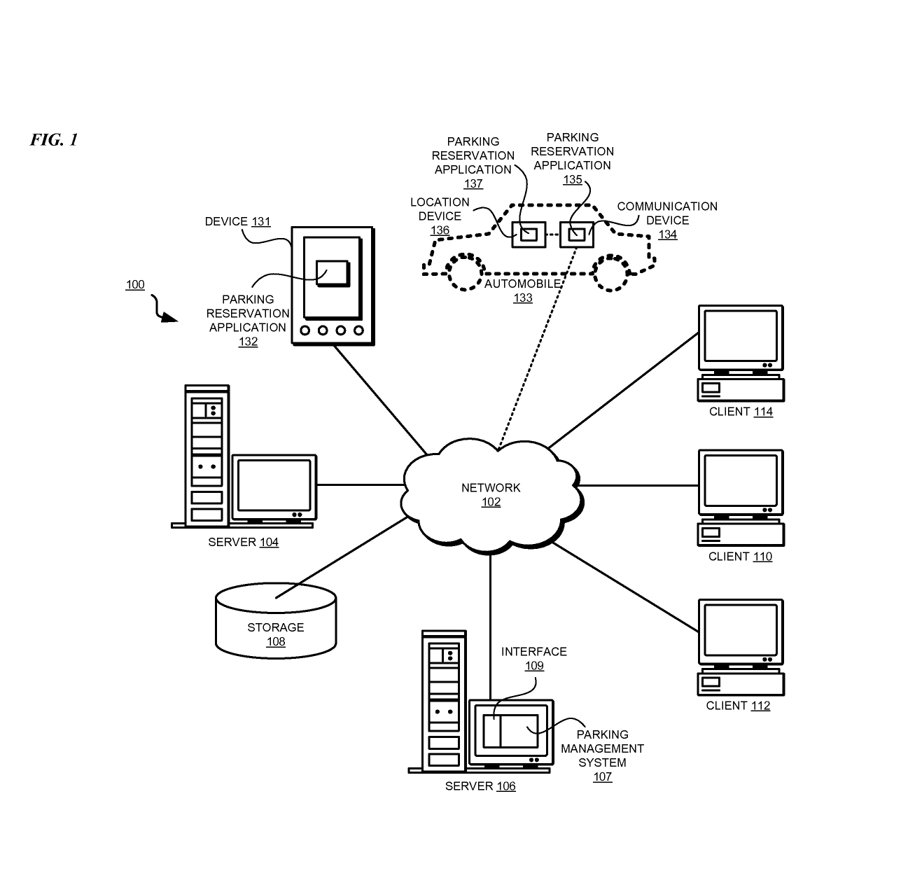

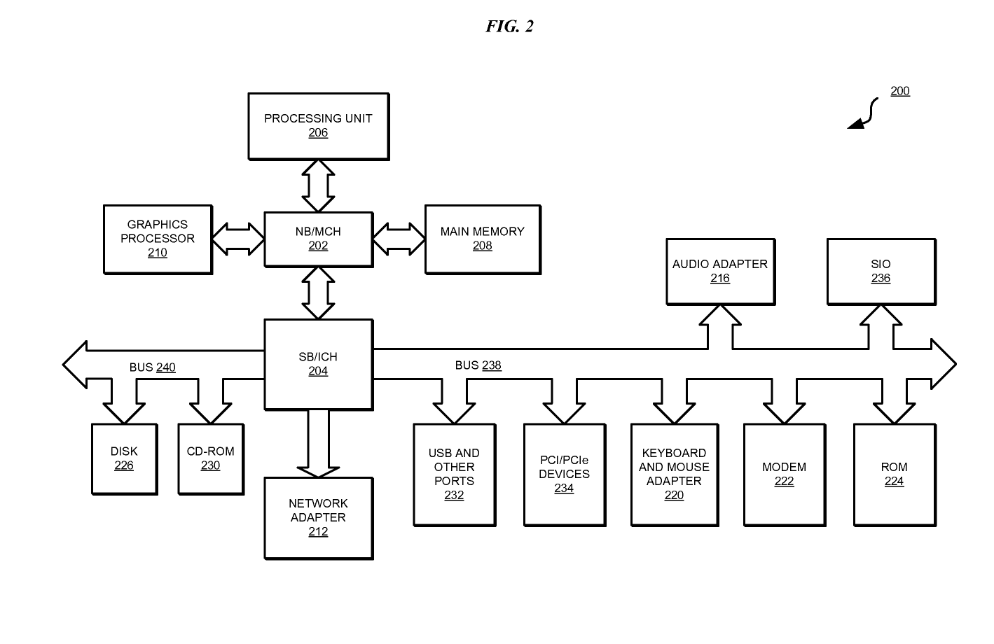

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114, may contain data and may have software applications or software tools executing thereon.

Only as an example, and without implying any limitation to such architecture, FIG. 1 depicts certain components that are usable in an example implementation of an embodiment. For example, server 106 implements parking management system 107, which includes an embodiment. Parking management system 107 provides interface 109. A parking reservation application can communicate with parking management system 107 via interface 109. Device 131 is any suitable mobile computing platform, for example, a smartphone, tablet computer, a portable data processing device, or a wearable computing device. Device 131 includes parking reservation application 132, from which parking management system 107 can receive a reservation request. Communication device 134 may be a device embedded in automobile 133, removably attached to automobile 133, carried by a person in automobile 133, or otherwise associated with automobile 133 in any suitable manner. Communication device 134 may be a person's cellular phone that enables parking reservation application 135 executing thereon to communicate with parking management system 107 wirelessly. Similarly, location device 136 may include parking reservation application 137, which can make a parking reservation with parking management system 107 while encouraging environmentally friendly driving practices in accordance with the illustrative embodiments.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, files related to the operating system and other software applications, and application features to clients 110, 112, and 114. Clients 110, 112, and 114 may be clients to server 104 in this example. Clients 110, 112, 114, or some combination thereof, may include their own data, boot files, operating system images, files related to the operating system and other software applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. A computer readable or usable storage device does not include propagation media. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as parking management system 107 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

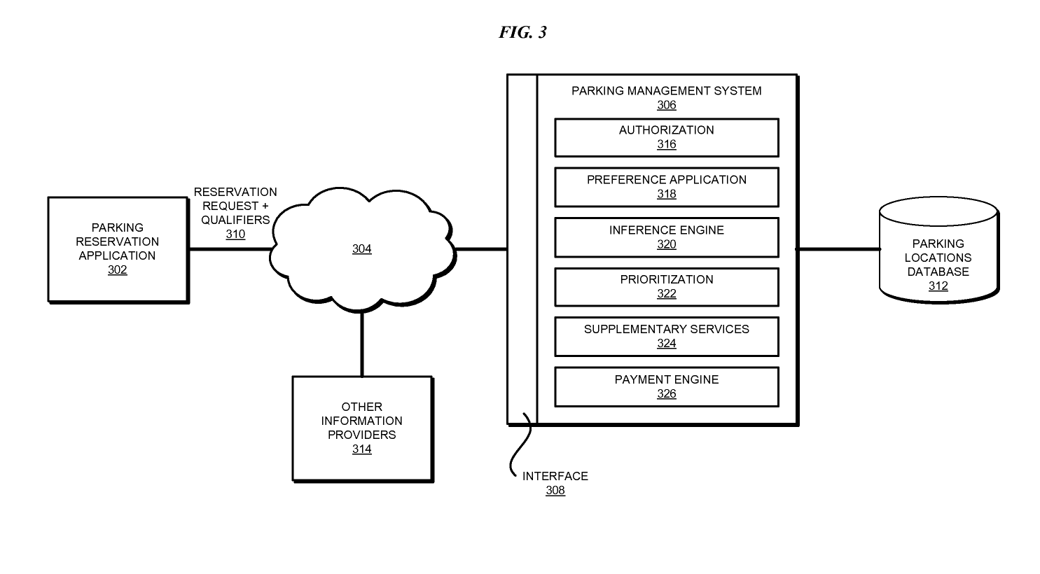

With reference to FIG. 3, this figure depicts a block diagram of an environmentally-friendly parking reservation system in accordance with an illustrative embodiment. Parking reservation application 302 can be implemented as parking reservation application 132, 135, or 137 in FIG. 1. Network 304 can be any combination of wired and wireless data communication networks implemented in the manner of network 102 in FIG. 1. Parking management system 306 and interface 308 are embodiments of parking management system 107 and interface 109 in FIG. 1, respectively. Parking management system 306 receives parking reservation request 310 along with any qualifiers over data network 304.

Parking management system 306 uses repository 312, which provides parking location information, such as in the form of a database or file. Using parking information from repository 312, parking management system 306 selects parking locations in response to reservation request 310.

Other information providers 314 is one or more data providers that provide data usable by parking management system 306 in selecting parking locations in response to reservation request 310. For example, a provider in other information providers 314 can be another instance of parking reservation application 302, which sends another request similar to request 310. When multiple requests for parking reservation arrive at parking management system 306, parking management system 306 sorts, prioritizes, or otherwise arranges the multiple requests in an order. Requests other than request 310 in the ordered requests then provide information usable for selecting a suitable parking location in response to request 310.

As another example, a provider in providers 314 may provide information about events in the vicinity of the parking area during various periods. Parking management system 306 uses such events information to change pricing, change desirability of certain parking locations, or provide supplemental services as described in this disclosure. A provider in providers 314 can also provide weather, traffic, delays, and other similarly usable information that can be used in making, modifying, delaying, canceling, changing, or otherwise manipulating a parking reservation. Other information providers 314 can be any number of data providers that provide data in these and other similarly purposed manner.

Parking management system 306 includes authorization component 316. Component 316 determines whether a user associated with request 310 is authorized to make a reservation. In one embodiment, component 316 enables a new user to establish authorization credentials to make the reservation. In another embodiment, component 316 allows a user to correct or change a status that prevents authorization, so that the reservation according to request 310 can proceed.

In one embodiment, component 316 also verifies the user or the vehicle upon arrival at the reserved parking location. For example, a device located at the parking location can detect the presence of the user or the vehicle using electronic, radio frequency, or hardcopy identifying information. Component 316 matches the identifying information with the information in a profile to authorize, alter, or decline the reservation for using of the parking location. For example, if the user makes a reservation using an environmentally-friendly driving qualifier of a car-pool, and only one mobile device associated with the reservation is detected upon at the parking location, the reservation can be modified to remove an environmentally-friendly driving credit that has been applied to the reservation.

Preference application component 318 applies user preferences to a reservation. For example, a user may have a user profile or a vehicle profile, which may be stored in (not shown) repository 312. A profile may include a preference that applies to the user or vehicle generally regardless of a parking area where the user intends to park the vehicle. A profile may include a preference that applies to a specific parking area, specific reservation periods, specific vehicles (such as when a user owns multiple vehicles), or a combination thereof. A profile can include these and many additional or different preferences, and the same are contemplated within the scope of the illustrative embodiments.

For example, consider a parking area near an office building where the user works. An example profile for the user can include a preference for Monday through Friday from 9 AM to 6 PM that the reservation should be made for the paring location nearest to exit A of the parking area and reservation qualifiers for car-pooling and low-emission vehicle should be applied to the reservation. Another preference for the user at the same parking area can be that on Saturdays, the reservations should be for a car-pooling family of four in a non-low-emission vehicle closest to exit B of the parking area. Another example preference for the user at a different parking area near an airport may be to reserve a remote parking location that is paved, where a non-car-pooling non-low-emission vehicle can be parked.

These example preferences are not intended to be limiting on the illustrative embodiments. Many other preferences for similar purposes will be apparent from this disclosure and the same are contemplated within the scope of the illustrative embodiments.

Component 318 applies a preference to select a parking location that is available during the requested reservation period. For example, in one embodiment, upon receiving request 310, parking management system 306 or a component thereof selects a parking location according from a list of parking locations where the list has been sorted according to some characteristic of the parking locations. The selection may be a default selection, first available location selection, round-robin selection across various parking sub-areas, or selection by any other suitable method. Component 318 then modifies that selection by moving up or down in the list, or selecting a different parking location from the list, according to a preference such that the different location meets the preference.

In one embodiment, component 320 assists in making the initial selection described above. Component 320 employs logic in the form of an inference engine. The inference engine of component 320 considers information available from other information providers 314 to determine a condition that may exist proximate to the parking area during the requested reservation period. For example, if the parking area is next to a stadium and a game is scheduled at the stadium during the requested reservation period, component 320 infers or determines that the reservation is being made to attend the game. Accordingly, the initial selection may be with reference to the exit for the stadium, and not with reference to another exit that may be closest to an office building.

As another example, component 320 can use a pattern of previous reservations by the user to determine an intended purpose for the reservations, and thereby infer or determine a preference to apply to the reservation. As another example, component 320 can use local events information from providers 314 to determine a different pricing for the reservations.

As another example, component 320 can use weather information from providers 314 to determine a different sorting order for the desirability of the parking locations from which to make selections for the reservations. As another example, component 320 can use enroute progress information from parking reservation application 302 to determine a different location for reservation 310 in the event of a delay.

As another example, component 320 can use request 310 to infer a designation for the vehicle for which the reservation is being requested. For example, an inference from request 310 may be that the vehicle is registered to a resident of the state or in a different state, or that the vehicle is designated a handicapped parking eligible vehicle, or that the vehicle belongs to a commuter or a resident, and so on. These example inferences are not intended to be limiting on the illustrative embodiments. Many other inferences can be made by component 320 in a similar manner within the scope of the illustrative embodiments.

Prioritization component 322 assigns priorities to the reservations that parking management system 306 is trying to accommodate at any given time. For example, at a particular time, several reservation requests similar to request 310 may be co-pending at parking management system 306 for the same parking area. Component 322 determines which parking location is assigned in response to a particular co-pending request based on the list of available parking locations, initial selection of parking locations, preferences applicable to those selections, inferences applicable to those selections, in relation to other co-pending requests.

In one embodiment, component 322 also prioritizes the parking locations in a parking area according to some criterion. For example, certain parking locations may be classified as “premium” owing to size of the parking location, position on the parking area, proximity of the parking location to an exit, slope or drainage in inclement weather, or a combination of these and other factors. The prioritization of the parking locations can then be used in creating the list from which to select the parking locations as described above.

These example prioritizations are not intended to be limiting on the illustrative embodiments. Many other manners of prioritizing can be employed by component 322 in a similar manner within the scope of the illustrative embodiments.

Component 324 determines additional or supplemental services that are applicable to a reservation. For example, if the reservation is made for attending a game, the game tickets can be offered, printed, discounted, or otherwise modified owing to the reservation. As another example, an advertisement for a collaborating business can be transmitted with the reservation confirmation as a supplementary service. As another example, if the reservation includes a car-pooling qualifier, and if the car-poolers are known from a pattern of previous reservations made by the users, an optimized routing for picking up or dropping off the pool members can be transmitted with the reservation confirmation as a supplementary service. As another example, if the reservation includes a qualifier indicating an environmentally friendly vehicle, a routing via charge stations or alternative fuel stops can be transmitted with the reservation confirmation as a supplementary service.

These example supplementary services are not intended to be limiting on the illustrative embodiments. Many other supplementary services can be provided by component 324 in a similar manner within the scope of the illustrative embodiments.

Component 326 implements a payment engine to manage payments for reservations, credits or incentives for reservations, applying earned credits, account balance maintenance, and any other financial or incentives-related matters arising in conjunction with the reservations. Component 326 can use any available tool for such operations. In one embodiment, among other aspects of reservation 310, component 326 tracks the use of an environmentally friendly vehicle, use of car-pooling or other environmentally-friendly driving practices, and awards payment credits, credits for future use, or other incentives to the reservation or the user's account.

While the features, functions, and operations occurring in parking management system 306 are described herein with respect to distinct components, an embodiment is not limited by the depiction or description of these example components. Those of ordinary skill in the art will be able to identify different components, additional components, or combinations of components to implement certain features, functions, or operations described herein, and such alternative manners of implementations are contemplated within the scope of the illustrative embodiments.

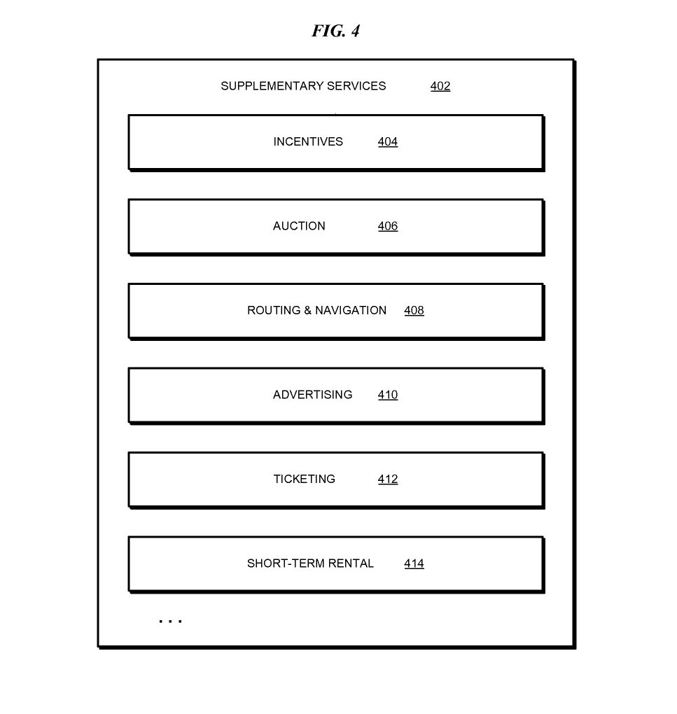

With reference to FIG. 4, this figure depicts a block diagram of example features of supplementary services usable in accordance with an illustrative embodiment. Supplementary services component 402 is an example embodiment of supplementary services 324 in FIG. 3.

As an example, supplementary services 402 includes component 404 to receive and manage incentives and offers from other information providers 314 in FIG. 3. Component 404 selectively makes the incentives and offers available to users, for example, in response to reservation request 310 of FIG. 3.

Auction component 406 allows a user to auction, exchange, or barter a parking location reserved by the user. As a result of the auction, exchange, or barter, component 406 can assign a different parking location, assign a parking location at a different time, deposit incentives or credits into a user's account, debit a user's account, or a combination thereof. Many other operations related to auctions, exchanges, or barters are possible in component 406, and the same are contemplated within the scope of the illustrative embodiments.

Routing and navigation component 408 composes and makes available for sending in response to a reservation request, optimized routing through certain waypoints. In one embodiment, the waypoints are determined from a user's reservation history. In another embodiment, the waypoints are determined based on a reservation request that is pending and the environmentally-friendly qualifiers associated therewith. Some non-exhaustive examples of the operations of routing and navigation component 408 are described with respect to FIG. 3 without implying a limitation thereto.

In one embodiment, component 408 also performs routing to a specific parking location in a “Just-In-Time” manner. For example, the parking management system may start by assigning a set of reservation requests to a block of parking locations, without assigning any specific parking location to any specific reservation request. As a vehicle holding a reservation approaches near the block of parking locations, or as the expected time of arrival gets closer or becomes more accurate, the parking management system refines the allocation of parking locations and assigns a specific parking location, such as the best available parking location at that time, to the vehicle. Component 408 then routes or navigates the driver, such as by providing successively more detailed driving instructions to the vehicle's navigation system. Alternatively, the specific parking location may not be committed until the vehicle is within a certain distance, depending on the number of parking locations available in the block of parking locations.

Advertising component 410 receives and manages advertising from other information providers 314 in FIG. 3. Component 410 selectively makes the advertising available to users, for example, in response to reservation request 310 of FIG. 3.

Ticketing component 412 enables a parking management system according to an embodiment to provide tickets or other documents related to events of interest to a user. The event or interest can be inferred from a reservation that the user makes, such as by using component 318 in FIG. 3. The event or interest can be indicated in the reservation request, such as in request 310 in FIG. 3. The ticket or other document can be electronically presented on a device associated with the user, printed at the parking location, such as via a printing device coupled with a parking meter, or transmitted to a user's device via a transmission device associated with the parking location. As an example, short-range radio frequency devices such as radio-frequency identification (RFID) or Bluetooth devices can be used for detecting the user or vehicle at the parking location, and for presenting, printing, or transmitting the ticketing or document information.

Short-term rental component 414 allows additional revenue generation from a reserved parking location. For example, if component 414 determines that a reserved parking location is not expected to be occupied until a pre-determined time-period later, additional use of the parking location can be allowed prior to the reservation time for less than that predetermined time-period. Component 414 can operate parking meters or other devices associated with the reserved parking location to allow such short-term use.

These example supplemental services, features, functions, and operations are not intended to be limiting on the illustrative embodiments. Furthermore, these services, features, functions, and operations are described herein with respect to specific components only as examples. An embodiment is not limited by the depiction or description of these example components. Those of ordinary skill in the art will be able to identify different components, additional components, or combinations of components to implement certain services, features, functions, and operations described herein, and such alternative manners of implementations are contemplated within the scope of the illustrative embodiments.

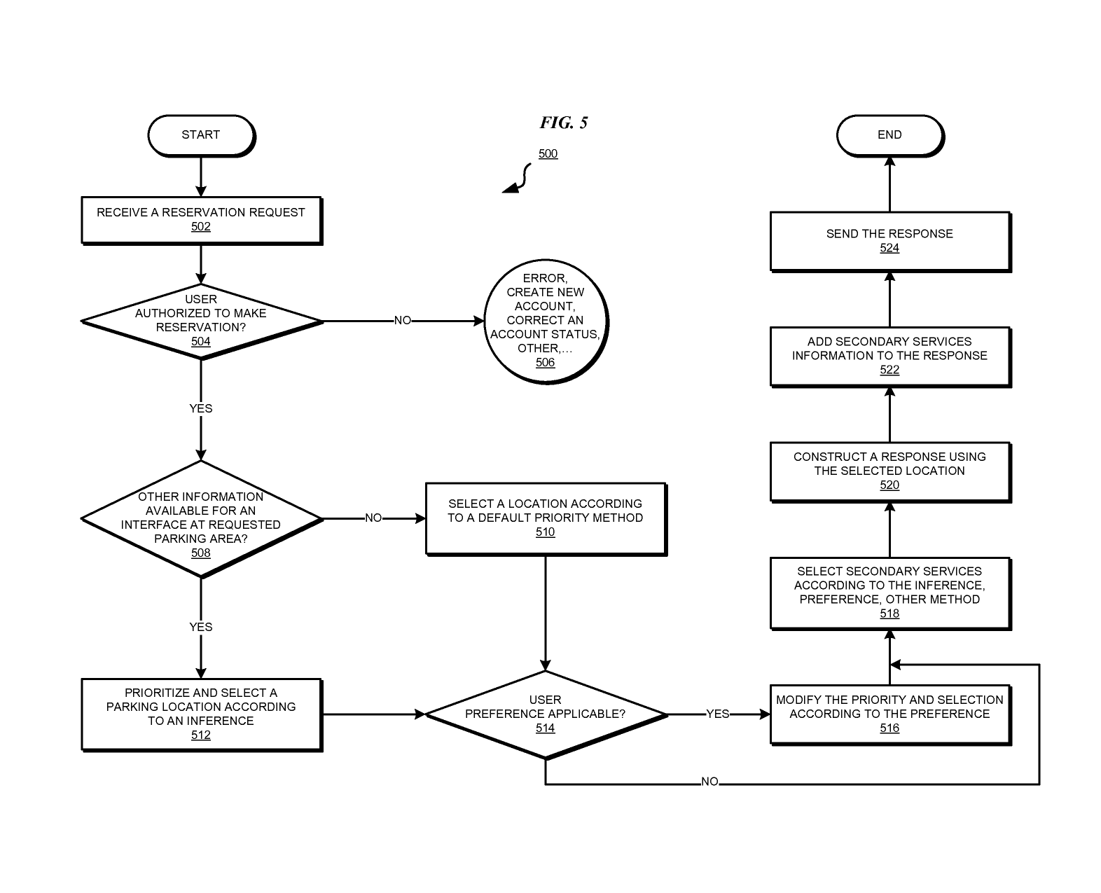

With reference to FIG. 5, this figure depicts a flowchart of a process for an environmentally-friendly parking reservation system in accordance with an illustrative embodiment. Process 500 can be implemented in a parking management system, such as parking management system 306 in FIG. 3.

Process 500 begins by the parking management system receiving a reservation request, such as request 310 in FIG. 3, for a parking location (step 502). The parking management system determines whether the user sending the reservation request is authorized to make the reservation (step 504). If the user is not authorized (“No” path of step 504), the parking management system diverts to another process where the parking management system can generate an error message, create a new account for a new user, correct an account status to reauthorize a user, or perform other functions related to a failed authorization.

If the user is authorized (“Yes” path of step 504), the parking management system determines whether other information is available for making an inference at the requested parking area (step 508). For example, the other information may be available from other co-pending reservation requests, other providers of information such as providers 314 in FIG. 3, a user's history of reservations, qualifiers associated with the reservation request, or a combination of these and other types of information.

If no such information is available (“No” path of step 508), the parking management system selects a location according to a default priority method (step 510). For example, in one embodiment, the parking management system selects a parking location that is going to be available during the requested reservation period from a sorted list of parking locations. Some example manners of sorting the list of parking locations and selecting a parking location there from are described elsewhere in this disclosure.

If some information for making an inference is available (“Yes” path of step 508), the parking management system prioritizes the request and selects a parking location according to the inference (step 512). Following either step 510 or step 512, the parking management system determines whether a user preference is applicable to the reservation request (step 514). If a preference is applicable to the request (“Yes” path of step 514), the parking management system modifies the priority of the request and the selection of parking location already made according to the preference (step 516). If a preference is not available or applicable (“No” path of step 514), the parking management system proceeds to step 518.

The parking management system selects applicable secondary services according to the inference, preference, or other factors (step 518). For example, at a certain time or upon a certain condition, the parking management system may offer a supplementary service in response to a reservation request regardless of any inferences or preferences.

The parking management system constructs a response using the location selection as modified according to the inferences, preferences, and priorities (step 520). The parking management system adds any secondary services that are selected in step 518 (step 522). The parking management system sends the response to the sender of the reservation request (step 524). Process 500 ends thereafter.

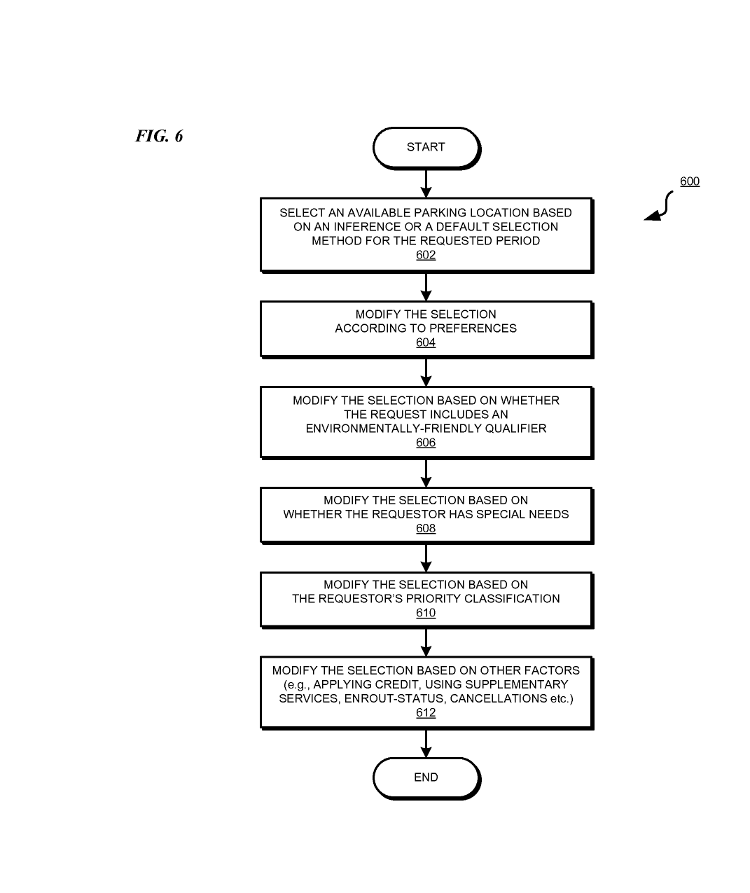

With reference to FIG. 6, this figure depicts an example process for modifying a selection of a parking location in accordance with an illustrative embodiment. Process 600 can be implemented in parking management system 306 in FIG. 3, such as in a combination of steps 510, 512, and 516 in FIG. 5.

Process 600 begins with the parking management system selecting an available parking location based on an inference or a default selection method for the requested period (step 602). The parking management system modifies the selection according to applicable preferences (step 604). The parking management system modifies the selection based on whether an environmentally-friendly qualifier, such as car-pooling or a low-emission vehicle, is present in the request (step 606). The parking management system modifies the selection based on whether the requestor has special needs, such as a need for a designated handicapped parking or a designated family-friendly parking (step 608). The parking management system modifies the selection based on whether the requestor has a priority classification, such as, for example, a frequent customer, a premium price paying customer, and the like (step 610). The parking management system modifies the selection based on other factors, such as for example, by applying a credit that changes a priority, agreeing to use a supplementary service that changes the priority inference or a preference, enroute status (e.g., delays) of the vehicle holding the reservation, cancellation of another reservation that makes a preferred location available prior to the reservation duration, and the like (step 614).

The modification steps are depicted sequentially without implying a limitation thereto. Process 600 can modify a selection using these modification factors in any suitable order, including omitting certain factors, adding other factors, using different factors, or combining certain factors within the scope of the illustrative embodiments. Process 600 may end thereafter or perform other modifications in a similar manner.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for an environmentally-friendly parking reservation system. An embodiment provides a process for making a reservation for a parking location by incentivizing environmentally-friendly vehicles or manner of driving.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for parking reservation, the method comprising:
a computer receiving a request to make a reservation for parking a vehicle in a parking area;
selecting, in an application, a parking location in the parking area, forming a selection;
the computer modifying the selection based on a qualifier in the request, the qualifier indicating an environmentally-friendly aspect of the vehicle; and
the computer generating a response, the response identifying the parking location.

2. The method of claim 1, further comprising:
the computer modifying the selection using an inference, wherein the inference is based on at least one of (i) the request, and (ii) information available at a time of receiving the request.

3. The method of claim 2, wherein the information comprises a second request for reserving a second parking location for a second vehicle.

4. The method of claim 2, wherein the response further includes a supplemental service, wherein the supplemental service is selected based on an inference from the information.

5. The method of claim 2, wherein the inference based on the request comprises a designation for the vehicle.

6. The method of claim 1, further comprising:
the computer modifying the selection using a preference applicable to the request, the preference being specified by a user identified in the request.

7. The method of claim 1, further comprising:
the computer modifying the selection using a pattern in a history of reservations made by a user associated with the request.

8. The method of claim 1, wherein the qualifier allows a benefit to be applied to the reservation by indicating that a level of occupancy in the vehicle exceeds a threshold level of occupancy.

9. The method of claim 1, wherein the qualifier allows a benefit to be applied a benefit to the reservation by indicating an environmentally-friendly characteristic of the vehicle.

10. The method of claim 1, further comprising:
the computer verifying whether the vehicle complies with the qualifier upon arrival of the vehicle at the parking location; and
the computer removing an incentive accrued to the reservation due to the qualifier responsive to the vehicle not complying with the qualifier.

11. The method of claim 1, further comprising:
the computer selecting a block of parking locations in the parking area;
the computer, upon a condition becoming true, performing the selecting of the parking location and guiding the vehicle to the parking location.

12. The method of claim 11, wherein the condition comprises the vehicle being within a predefined distance from the block of parking locations.

13. A computer program product comprising one or more computer-readable tangible storage devices and computer-readable program instructions which are stored on the one or more storage devices and when executed by one or more processors, perform the method of claim 1.

14. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

15. A computer program product for parking reservation, the computer program product comprising:
one or more computer-readable tangible storage devices;
program instructions, stored on at least one of the one or more storage devices, to receive a request to make a reservation for parking a vehicle in a parking area;
program instructions, stored on at least one of the one or more storage devices, to select a parking location in the parking area, forming a selection;
program instructions, stored on at least one of the one or more storage devices, to modify the selection based on a qualifier in the request, the qualifier indicating an environmentally-friendly aspect of the vehicle; and
program instructions, stored on at least one of the one or more storage devices, to generate a response, the response identifying the parking location.

16. The computer program product of claim 15, further comprising:
program instructions, stored on at least one of the one or more storage devices, to modify the selection using an inference, wherein the inference is based on at least one of (i) the request, and (ii) information available at a time of receiving the request.

17. The computer program product of claim 16, wherein the information comprises a second request for reserving a second parking location for a second vehicle.

18. The computer program product of claim 16, wherein the response further includes a supplemental service, wherein the supplemental service is selected based on an inference from the information.

19. The computer program product of claim 16, wherein the inference based on the request comprises a designation for the vehicle.

20. A computer system for parking reservation, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to receive a request to make a reservation for parking a vehicle in a parking area;
program instructions, stored on at least one of the one or more storage devices for execution by at least one of the one or more processors via at least one of the one or more memories, to select a parking location in the parking area, forming a selection;
program instructions, stored on at least one of the one or more storage devices for execution by at least one of the one or more processors via at least one of the one or more memories, to modify the selection based on a qualifier in the request, the qualifier indicating an environmentally-friendly aspect of the vehicle; and
program instructions, stored on at least one of the one or more storage devices for execution by at least one of the one or more processors via at least one of the one or more memories, to generate a response, the response identifying the parking location.
